(19) United States
(12) Patent Application Publication
(10) Pub. No.: US 2006/0040727 A1
(43) Pub. Date: Feb. 23, 2006

(54) Bingo system with dynamic game play result ordering

(76) Inventors: Clifton Lind, Austin, TX (US); Jefferson C. Lind, Austin, TX (US)

Correspondence Address: THE CULBERTSON GROUP, P.C., 1114 LOST CREEK BLVD., SUITE 420, AUSTIN, TX, 78746, US

(21) Appl. No.: 10/922,451

(22) Filed: Aug. 20, 2004

(51) Int. Cl. G06F 19/00; G06F 17/00

(52) U.S. Cl. 463/19

(57) ABSTRACT

A method, apparatus, and program product for conducting bingo games that includes using a server to collect game play requests from a plurality of player stations. A first player and at least one additional player may submit multiple game play requests, and a server may separate the game play requests into at least two bingo games and conduct the bingo games simultaneously. Results for the bingo games are displayed at a player station in an order determined dynamically based at least in part on the order in which game results become available from the server.

### CROSS-REFERENCE TO RELATED APPLICATION

This application is related to U.S. patent application Ser. No. 10/456,721 filed Jun. 6, 2003, and entitled “METHOD, SYSTEM, AND PROGRAM PRODUCT FOR CONDUCTING MULTIPLE CONCURRENT BINGO-TYPE GAMES” which claims the benefit of U.S. Provisional Patent Application Ser. No. 60/444,503 filed Feb. 3, 2003, and entitled, “RAPID PLAY ELECTRONIC BINGO GAMING SYSTEM,” the entire content of these applications being incorporated herein by this reference.

### TECHNICAL FIELD OF THE INVENTION

This invention relates to electronic gaming systems enabling players from many different gaming locations to participate in bingo games. More particularly, the invention is directed to apparatus, methods, and program products for aiding players in the rapid and secure play of bingo games and for enhancing player participation in bingo games.

### BACKGROUND OF THE INVENTION

The game referred to generally as “Bingo” is played with predetermined bingo cards that include a number of designations randomly arranged in a grid or other layout of spots or locations. The bingo cards may be physically printed on paper or another suitable material, or may be represented by a data structure which defines the various card locations and designations associated with the locations. In the traditional bingo game sequence, a number of the predetermined bingo cards are put in play for a particular game. After the sale of bingo cards is closed for a given game, designations are randomly selected from a pool of available designations and matched to the designations on each bingo card that is in play in the game. This matching of bingo designations randomly selected for a game and bingo designations associated with a card in play in the game is commonly referred to as daubing the card and results in a pattern or arrangement of matched spots or card locations. Daubing was done manually by the player holding the bingo card in traditional bingo games, and then by a game administrator to verify a win in the game. More recent bingo gaming systems automatically check for winning patterns on a bingo card as designations are randomly selected for a game. Regardless of how the bingo cards in play in a game are daubed, the first card which is daubed in some predefined way is considered a winning card for the game. The predefined way in which a card must be matched or daubed to produce a win in the game is commonly defined in terms of some identifiable pattern of matched or daubed locations on the card.

Although traditional bingo games remain popular, traditional paper bingo games are played relatively slowly. The card purchasing or buy-in period, the sequential ball draw and announcement of each individual designation, and then winner verification together consume a good deal of time. The time required to play a traditional bingo game limits the player excitement with the game and thus limits player satisfaction.

Various systems have been developed to aid players in playing bingo games and to enhance player participation in the games. The MegaMania™ gaming system offered by Multimedia Games, Inc. comprises a bingo gaming system in which players at different gaming facilities over a large geographic area may participate in bingo games. The players participate in bingo games in the MegaMania™ system through electronic player stations that are maintained at various gaming facilities across the United States.

Electronic bingo gaming systems and electronic player stations may increase the speed at which certain operations in a bingo game may be performed. However, even in an electronically implemented bingo game, the rules or regulations under which the game must be conducted may continue to introduce delays in identifying the game results and displaying those results to the various participants in the bingo game. This is particularly true where game rules require the players to take some action to daub their card and/or take some action to claim a prize. Where a player in a given bingo game is delays taking the required action or actions to complete the game, the results for all of the others players in that game may also be delayed.

### SUMMARY OF THE INVENTION

The present invention provides apparatus, methods, and program products for conducting bingo-type games. A method embodying the principles of the present invention includes receiving two or more game play requests from each of a number of players. Each game play request represents a request to enter a bingo card representation in a bingo game. The game play requests are grouped such that the different game play requests for each of the players are included in different bingo games. The games are then conducted to identify a result for each game play request. The results for each of the game play requests are then presented to each of the players in an order based at least partially on the availability of game results for the respective bingo games in which the bingo game plays were received. By enabling the players to enter game play requests for multiple games simultaneously, concurrently, or in rapid succession, and by presenting the results for the multiple games based partially on the availability of game results, it is possible to present game results to the various players in a way that minimizes the delay that may be introduced when the bingo game rules require various player actions in the bingo games.

In another aspect of the invention, one or more player actions may be applied as a respective required action in each of a number of simultaneously or concurrently conducted bingo games. Applying the player action to the multiple bingo games may allow the games to be completed more quickly. Thus, the game results may be presented to the players more quickly, or with minimum delay between the individual game result presentations.

An apparatus embodying the principles of the invention includes two or more player stations. Each player station includes a display for displaying the result of different bingo games and an input device through which a respective player may make an input or inputs to initiate multiple game play requests, each game play request comprising a request to enter the player in a respective bingo game. Each player input device also enables a player to make one or more player inputs that may represent required actions in the course of a bingo game. The apparatus also includes a bingo game result module that receives the game play requests and identifies a bingo game result for each game play request, that is, a result for each bingo game in which the player is entered as a result of a respective game play request. An ordering module collects the results of the different bingo games as they become available and makes various results available to the respective player stations for display to the respective players in an order determined dynamically for a respective player or player station based at least in part upon the availability of the results for the different games. This dynamic ordering of result presentations at the player stations may be employed to provide a respective player with entertaining result presentations for some of the multiple bingo games that the player entered while results are still pending in other of the bingo games due to relatively slow player actions or for other reasons. Thus, the dynamic ordering of result presentations may be used to prevent periods of inactivity at the player stations that would otherwise occur in playing bingo games.

A program product embodying the principles of the invention includes a set of machine-readable instructions that when executed are configured to receive multiple bingo game play requests from a first player and at least one additional player and to group the received game play requests such that the multiple game play requests for the first player are included in different bingo games. When executed, the instructions are also configured to conduct each respective bingo game to identify a result for each of the different game play requests for the first player. The instructions are also configured upon execution to present the result for each of the different game play requests to the first player in an order at least partially based on result availability for the respective bingo games. The ability to have multiple bingo game results available for presentation to a player and the dynamic ordering of result presentation based on result availability enables the program product to avoid inactivity at the player stations occasioned by any number of circumstances, including delayed player daubing and/or prize claiming actions in some of the bingo games.

These and other advantages and features of the invention will be apparent from the following description of the preferred embodiments, considered along with the accompanying drawings.

### BRIEF DESCRIPTION OF THE DRAWINGS

FIG. 1 is a high level diagrammatic representation of a bingo gaming system embodying the principles of the present invention.

FIG. 2 is a flow diagram illustrating a gaming method embodying principles according to the present invention.

FIG. 3 illustrates game results that are identified for multiple bingo games performed in the bingo gaming system of FIG. 1.

FIG. 4 is a time line table representing potential displays available at the electronic player stations described in FIG. 3 during progression of multiple bingo games in the bingo gaming system of FIG. 1.

FIG. 5 is a table illustrating game results in the system shown in FIG. 1 when five players each make five game play requests entered in five different bingo games.

FIG. 6 is a time line table illustrating a potential order for the display of the game results in the table of FIG. 5.

### DESCRIPTION OF PREFERRED EMBODIMENTS

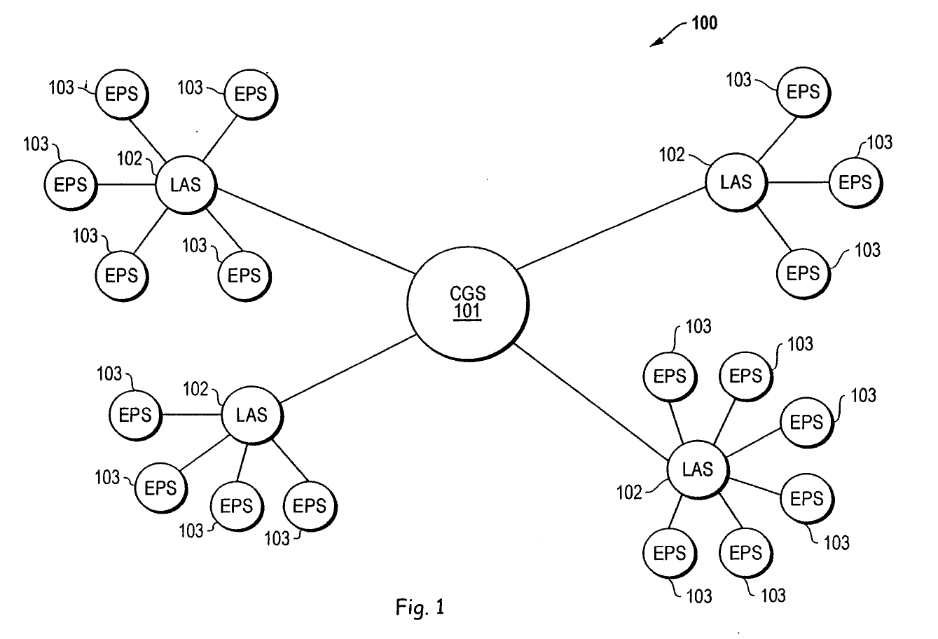

FIG. 1 shows a gaming system 100 including a central game server (CGS) 101 that cooperates with a number of other components to enable bingo players, preferably at many different remote gaming sites, to participate in bingo games. Each gaming site includes a local area server (LAS) 102 and a number of electronic player stations (EPSs) 103. In the normal operation of gaming system 100, a player at any EPS 103 in the system may participate in a given bingo game with players at any other EPSs 103 in the system by making or initiating a “bingo game play request” or “game play request” at the respective EPS 103. Thus, players at different gaming facilities may be grouped together for a given bingo game administered through system 100. Grouping together players from different gaming facilities for the play of a bingo game helps to allow different bingo games to be played rapidly and minimizes the time that players must wait to have their game play requests entered in the respective bingo games.

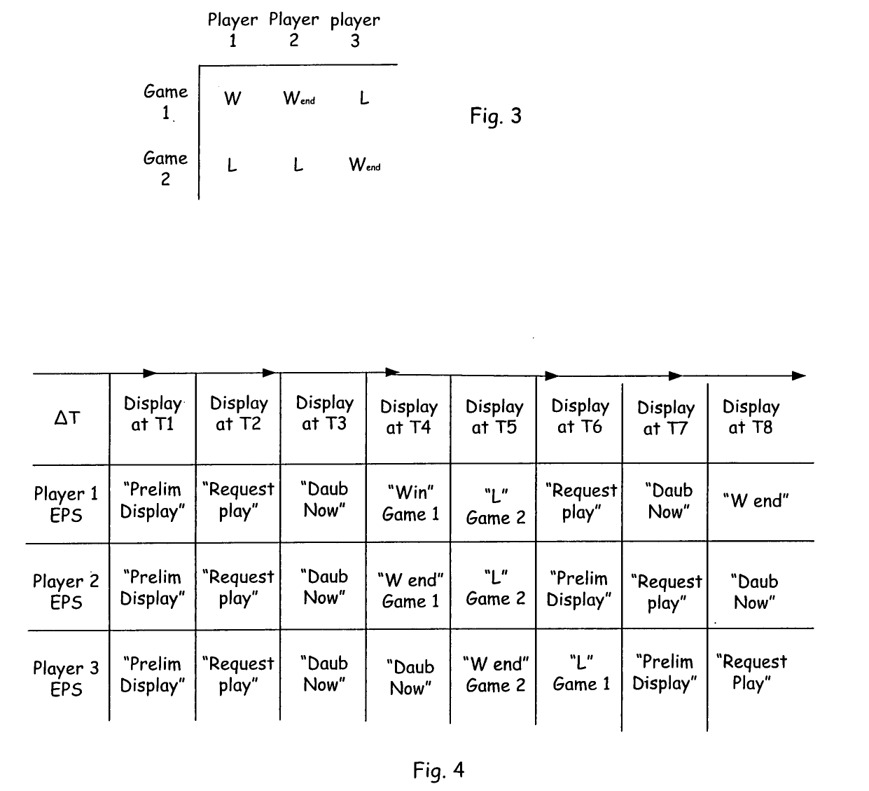

The invention includes an arrangement for grouping players for the play of multiple bingo games to facilitate rapid play. In particular, rapid play may be facilitated by enabling players to initiate multiple game play requests either simultaneously or in rapid short succession so that the players may play multiple bingo games essentially simultaneously or concurrently. According to the invention, the results for the multiple game play requests are displayed in an order that is dynamically determined based at least partially on when game results become available. Thus, as will be described in detail below with reference to examples in FIGS. 3, 4, 5, and 6, the results for the various game play requests initiated simultaneously or nearly simultaneously may be presented in an order to ensure continuous entertainment at the EPS 103 even when results are delayed for some of the multiple game play requests for one reason or another.

System 100 may reduce the time between a game play request at one of the EPSs 103 and the return of results to the respective EPS sufficiently to allow a great deal of flexibility in how results in the bingo game are displayed to the player. In particular, results for the various game play requests in system 100 may be displayed at an EPS 103 in a traditional bingo game result format or in some format unrelated to bingo. As described in U.S. patent application publication 2002-0132661-A1, incorporated herein by this reference, results may be presented to the player as a reel-type (slot machine) game result, card game result, or any other type of result. Also, bingo game results may be combined into a combined or composite result that represents a combination or an accumulation of several individual bingo game results.

The grouping of players for conducting multiple bingo games according to the present invention may include limiting the number of players that participate in each of the multiple bingo games. Limiting the number of players that participate in each of the multiple bingo games may help reduce the time required for grouping players and thus reduce the time required to return results to the players after game play requests have been initiated. This grouping of players or game play requests to facilitate more rapid play may be accomplished as described in U.S. patent application Ser. No. 10/456,721, entitled “Method, System, and Program Product for Conducting Multiple Concurrent Bingo-Type Games” which is incorporated herein. For example, each bingo game offered through gaming system 100 shown in FIG. 1 may be limited to between 2 to 20 players, with the preferred number of players for any given game being from 10 to 15. This limited number of players or game play requests that may be included in a bingo game according to the present invention may be referred to as a quorum.

Regardless of the rapid play facilitated by system 100 and regardless of the manner in which the bingo game results are displayed, the underlying game remains a standard bingo game played in the traditional sequence of play for bingo games. That is, each player obtains or is assigned a bingo card or bingo card representation, all bingo card representations in play in the game are daubed or checked for matches with a randomly generated sequence of designations (for example, designations produced in a ball draw or produced by a random number generator), and the first card in the game to match the sequence of designations to produce the game ending winning pattern wins the bingo game. Additional prizes may be awarded for other patterns that may be produced in the course of the bingo game. The mapping of different prizes to various bingo patterns that may be produced in the course of a bingo game in system 100 may be accomplished as described in U.S. Pat. No. 6,569,017, entitled “Method for Assigning Prizes in Bingo-Type Games” or U.S. patent application publication No. 2004-0048647-A1, entitled “Prize Assignment Method and Program Product for Bingo-Type Games.” The entire content of each of these prior publications is incorporated herein by this reference.

CGS 101 may comprise a computer system (not shown) that may include one or more processors, nonvolatile memory, volatile memory, a user interface arrangement, and a communications interface, all connected to a system bus. It will be appreciated that the user interface arrangement may include a number of different devices such as a keyboard, a display, and a pointing device such as a mouse or trackball for example. Regardless of the particular configuration for CGS 101, in the normal operation of system 100, the CGS 101 implements a bingo game result module or bingo engine that receives game play requests originating from EPSs 103 across system 100, groups the game play requests for participation in different bingo games, produces or obtains sequences of designations (ball draws, for example) for the play of the bingo games, identifies the respective result for each game play request in each bingo game, and communicates the results to LASs 102.

As used in this disclosure any sequence of designations that may be matched against bingo cards or card representations in the present gaming system will be referred to as a “ball draw” regardless of how the sequence is actually generated. Under this definition, it will be appreciated that a ball draw may be produced by a random number generator, a pseudo random number generator, or any other suitable device or system, and not necessarily a physical ball draw device.

Each LAS 102 included in system 100 as shown in FIG. 1, and as described in the incorporated U.S. patent application Ser. No. 10/456,721, may comprise a computer system (not shown in the present application) having one or more processors, nonvolatile memory, volatile memory, a user interface arrangement, and communications interface, all connected to a system bus. Regardless of the specific configuration of the LAS 102, each LAS serves, in normal operation of the system 100, to transfer or relay information from its respective EPSs 103 to CGS 101 and transfer or relay information such as bingo game results from the CGS to the LAS's respective EPSs. In some forms of the present invention each LAS 102 may implement a result ordering module for dynamically ordering the results for its various EPSs 103 as will be described further below. Also, each LAS 102 may be configured to perform the tasks normally performed by CGS 101 in the event the communications link between the respective LAS and CGS is degraded below a certain level or is severed altogether or under certain other operational conditions. For example, where one LAS 102 serves a large number of EPSs 103, the LAS may group players or game play requests from its respective EPSs during a time of high player activity, obtain or produce a ball draw, identify results, and return results to the EPSs rather than having the CGS 101 perform these tasks.

An EPS 103 used in a gaming system embodying the principles of the present invention may include a processor, a communications interface to facilitate communications with the respective LAS 102 and/or CGS 101, a player interface arrangement to facilitate player participation in the bingo games offered through gaming system 100 and to display game results in an exciting and attractive format (EPS processor, communications interface, and player interface not shown). Among the other control functions which may be performed by the EPS processor, the processor for each EPS may implement a result ordering module for the respective EPS as will be discussed further below. This EPS based result ordering module would be in lieu of such functionality at the LASs 102 or CGS 101. The EPS player interface may include player controls, a display or touch screen display, a sound system, and perhaps other features such as alarms or special displays or alerting devices. Each EPS 103 also preferably includes a convenient system for allowing the player to input player-specific information and for receiving wagers and dispensing winnings. For example, the EPS 103 may include a player card reader that is adapted to read player-specific information from a player account card inserted into the reader. A player account card may, for example, include player information or simply a player identifier encoded on a magnetic medium (mag stripe) associated with the card, or encoded on bar code, or a memory device associated with the player card. EPS 103 may also include a device for receiving value and issuing value in the course of play. This device may accept currency, vouchers, or tokens, for example, and also output currency, vouchers, or tokens. Of course a separate device may be used to receive and issue value for games played according to the present invention. Alternatively or in addition to a value in/out device, EPSs 103 may read player account information from the player card or player information otherwise input at the EPS, and account for wagers and winnings in the manner set out in U.S. patent application publication No. 2002-0132666-A1 entitled “Distributed Account Based Gaming System,” the entire content of which is hereby incorporated herein by this reference.

It will be appreciated that, as described in U.S. patent application Ser. No. 10/456,721, incorporated herein, the particular configuration of devices shown in FIG. 1 is shown only for purposes of example. A bingo gaming system according to the present invention may omit some or all of the separate LAS's 102 at the various gaming facilities so that the EPS's 103 communicate directly with CGS 101. Also, various regions or different gaming facilities may be divided up into separate systems each having a respective CGS such as CGS 101. In these situations the system could be configured such that a single EPS 103 may be serviced by any of the CGSs. Furthermore, a gaming system embodying the principles of the invention may include multiple CGSs rather that a single CGS 101 as shown in FIG. 1. Also, the invention is not limited to the particular quorum based grouping of game play requests or players described in U.S. patent application Ser. No. 10/456,721, although such grouping is a preferred implementation of the present invention.

It will also be appreciated that the CGS 101, each LAS 102, and each EPS 103 in preferred forms of the invention operates under the control of operational program code. The game play request grouping and result identification preferably performed by CGS 101 is preferably performed under control of program code executed at the CGS. The relay or other functions performed by each LAS are preferably performed under control of program code executed at the LAS processor or processors. Similarly, the functions performed by each EPS 103 is also performed under the control of program code executed at the respective EPS. Whether performed at the LASs, EPSs, or some other element in system 100, the result ordering according to the present invention is also performed preferably under the control of program code executed at the respective element.

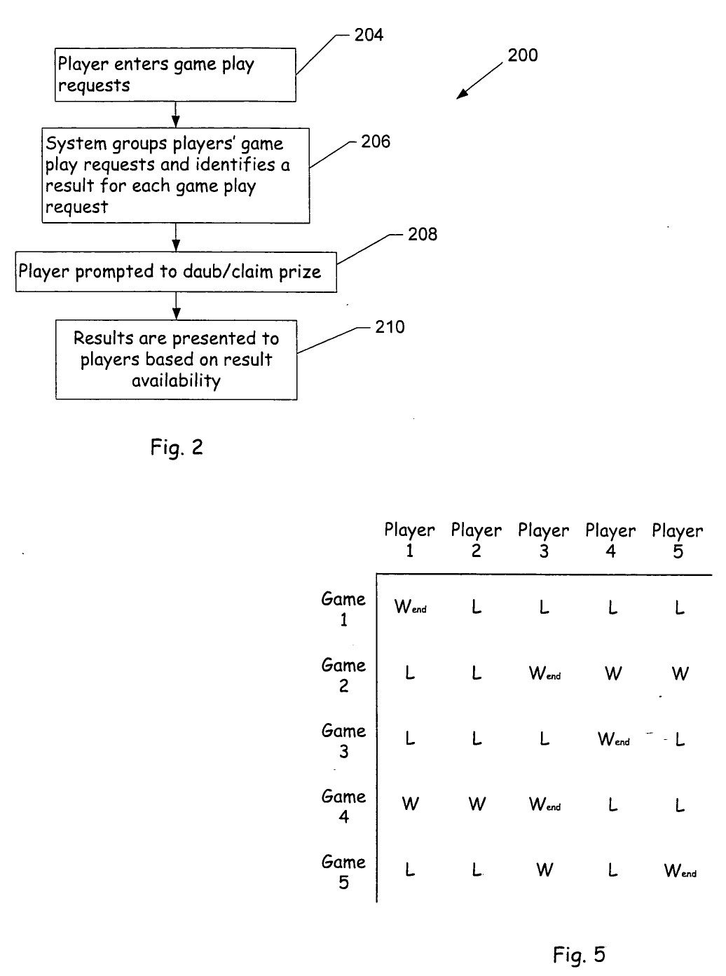

The flow diagram 200 shown in FIG. 2 illustrates a gaming method embodying principles according to the present invention. At process block 204 the player makes a suitable input at their respective EPS 103 to enter a number of respective game play requests each in a different bingo game. Each game play request is associated with a respective bingo card representation comprising a data structure that defines each location of the bingo matrix or other structure. This association between a respective game play request and bingo card representation may be made in a number of different ways within the scope of the invention. In one preferred form of the invention, the association is made automatically by EPS 103, LAS 102, or CGS 101 upon entry of the game play input of the player or at some point in time after entry of the game play input. In other preferred forms of the invention, the player may choose his or her bingo card representations from a set of available bingo card representations or may even build their own bingo card representations. It will be noted that some forms of the invention may not require that a separate bingo card representation be associated with each different bingo game. Rather, it is possible and within the scope of the invention for a player to make a game play input that associates the same bingo card representation with multiple game play requests and thus enters the same bingo card in multiple bingo games. It will also be noted that although the preferred forms of the invention require only a single input from a player to enter multiple game play requests, other forms of the invention may require or allow multiple player inputs to enter multiple game play requests. Also, some preferred forms of the invention allow the player to select or designate the number of game play requests that are included in a game play input. In other forms of the invention, the number of game play requests for a given game play input are predefined in some fashion. For example, a game play input associated with a wager of 25 credits may be predefined as making five game play requests, each associated with 5 credits. At the same EPS 103, a wager of 50 credits may be predefined as making five game play requests each associated with 10 credits.

At process block 206, game play requests from across system 100 are grouped into different bingo games. The game play requests may be grouped in any suitable fashion. In one preferred form of the invention, game play inputs associated with a common number of game play requests have their associated game play requests grouped together according to the time that the game play requests are received by the system element responsible for grouping (such as CGS 101). In other forms of the invention, game play requests are grouped in an ad hoc fashion without regard to any commonality or dissimilarity in the number of game play requests per game play input. It will be noted that grouping may be accomplished as described in U.S. application Ser. No. 10/456,721 with collected game play requests being collected in a queue or other data structure. Preferably, however, the game play request collecting component (such as a bingo game result module implemented through CGS 101) maintains a number of queues or other data structures concurrently and places each game play request submitted by a given player in a different queue. The game play requests are then collected in the various queues until a quorum is reached for the respective queue. Regardless, of the manner in which incoming game play requests are collected or held pending the formation of the desired groups of game play requests, when a group of game play requests has been formed in accordance with the particular rules of the system 100, a bingo game is conducted between the collected game play requests and the results for the bingo game are identified by an appropriate element in the system such as CGS 101 implementing a bingo game result module.

At process block 208 each player may be requested to daub their cards or take one or more other actions which may be required to claim a prize so that each bingo game may be completed. A single daub or other action/input by a player may apply to all of the games that a player has entered, that is, may apply to all of the currently pending or outstanding game play requests for that player. It will be appreciated that players may daub at different times, and that some players may even fail to daub or take some other required action within an allowed period of time. Thus, the various bingo games may require different periods of time to complete and the results for a player's various game play requests made simultaneously or in rapid succession may be available at different times.

As indicated at process block 210, as the bingo games are completed and results become available for the various games, the results are made available to the respective EPSs 103 and are ultimately displayed to the respective players. In one preferred form of the invention, a result queue or other storage arrangement is maintained for each EPS 103 either at the EPS or its respective LAS, and each result for a game play request entered through the respective EPS is stored in the respective result queue when it becomes available. Other forms of the invention may include checking periodically for available results and then making those results available to the respective EPSs 103 in some suitable manner. Ultimately, the results for the various game 1 play requests that have been entered through a respective EPS 103 are displayed to the player in some suitable game presentation at that EPS 103. These results are presented in an order at least partially based on the order of completion of the games or the order in which results become available in the various games. For example, results for the various game play requests entered by a player may be collected in a first-in-first-out (FIFO) queue for each respective EPS 103 and thus results may be displayed purely in the order in which results become available and are stored in the results queue. Alternatively, results collected in a result queue for an EPS may be taken and displayed to the player according to some bias or rule, such as oldest pending game play request first, or winning game plays first, or winning and losing game plays presented in an even distribution. Regardless of where the ordering is performed in the system or how it is performed, the dynamic ordering of results is preferably performed by a result ordering module. This dynamic ordering of game play results for the respective game play requests may be employed to prevent delays or periods of inactivity at an EPS 103 that may be occasioned when a particular bingo game is slow to complete for some reason, such as when a player is slow to take some action required to complete a respective bingo game.

It will be noted that results for the various game play requests may be initially or preliminarily identified at block 206 even though the players have not made any required actions which are prompted at block 208. Assuming that the players take the required actions to claim their prizes after the prompt at block 208, the results initially identified for the given bingo game become the final results for the game. However, should a player fail to take the required action after prompting at block 208, further action may be required at the bingo game result module (such as CGS 101) to identify the final results in the game. For example, additional balls or draw designations may need to be considered to identify the final results for the given game. Some of the initial results identified in the game may be superceded by other results depending upon the rules of the bingo game. The results that are identified and made available for presentation to a player according to the present invention are the final results identified by the bingo game result module.

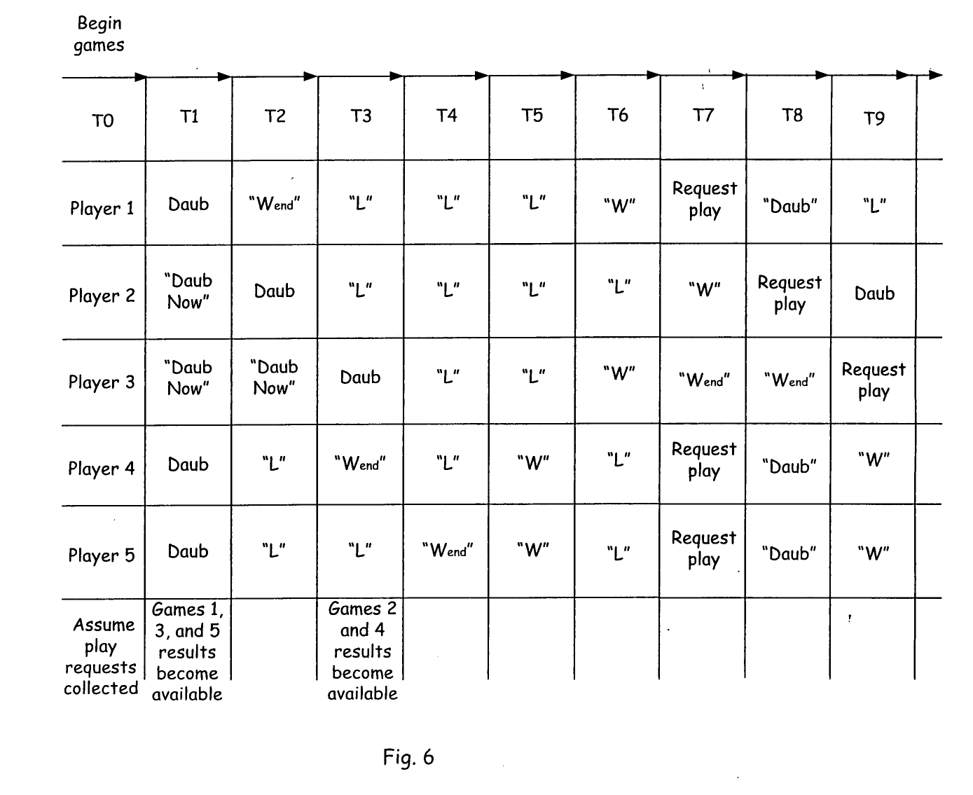

In some forms of the invention, the step of displaying or presenting the various bingo game results to a given player at an EPS 103 may include combining the results from different bingo games into a combined or composite result and then presenting that combined or composite result. This combining of results for presentation may be performed by the result ordering module. Combining individual bingo game results may be particularly attractive where there is no delay in result availability for a number of concurrently pending game play requests. In this situation there is no need to show each result individually while other results become available. Thus, showing multiple results in a combined or composite result representing the cumulative result for a number of game play requests allows the results to be displayed more quickly and more quickly returns the EPS 103 to a state in which further game play requests may be entered. Examples of result combinations according to the invention will be described below with reference to FIG. 4 and FIG. 6.

Prior to the presently disclosed invention, and assuming that the applicable bingo game rules required a player daub input, if a player (for example, player A) failed to daub in a timely fashion, results would not be displayed to any player for any games in which player A first achieved the respective game ending pattern. Thus, in the past, if player A held a game ending pattern for game 1 and results were displayed to all players in the order of the games, player A's delay would cause the other quicker players to wait on player A's daub in order to see the results of game 1. This problem was aggravated when player A failed to daub at all, that is, slept the bingo. In that case some bingo regulations required additional balls or designations to be considered until a new game ending pattern was achieved in the game. This additional action to end the bingo game slowed the display of results even further. The present invention, however, may be used to eliminate delays that are occasioned by the slow play or errors of other players as will be illustrated in the following examples.

FIG. 3 illustrates game results that are identified for games 1 and 2. Transparent to the players 1, 2, and 3 playing through respective EPSs, results for games 1 and 2 are identified by the suitable bingo game result module and then, as illustrated in FIG. 4, are displayed in an order conducive to avoiding delays for any of the players at the three EPSs. FIG. 3 shows that player 1 has no game ending wins in the two bingo games, but has a win for game 1 and a loss (no payout) for game 2. Player 2 at another EPS has a game ending win for game 1 and a loss for game 2, and player 3 at yet another EPS has a loss for game 1 and a game ending win for game 2.

FIG. 4 is a time line table representing potential displays available to players 1, 2, and 3 at their respective EPS during progression of the two bingo games in the bingo gaming system of FIG. 1. At time period T1, each of the EPSs show a “Preliminary Display” while waiting for a player to initiate or enter game play requests at the respective EPS. Part of this Preliminary Display may be an interface or dialog that allows a player to define their bingo card representations. Alternatively, the bingo card representations may be defined or assigned from an available pool automatically by the system 100 after an input is made to initiate game play requests, or may be previously defined by the player, or may be defined in any other suitable manner. The Preliminary Display state may also include a display in which the player may enter a wager amount and/or enter funds to cover wagers, and/or perform any other activity preliminary to initiating game play requests.

At time T2 in FIG. 4 the EPSs each produce a display that allows the respective player to make some input that initiates multiple game play requests. This display state is shown as “Request Play” in FIG. 4. As mentioned above, preferred forms of the invention require only a single player input at their EPS 103 to initiate the multiple game play requests. However, the invention encompasses the situation in which a player may be required to make a separate input for each game play request or any other input sequence or requirement for entering the desired multiple game play requests through the display state “Request Play” shown at T2. Due to the players initiating game play requests at each EPS during time T2, at time period T3, the EPSs change their respective displays to a “Daub Now” display. In this display state, the player is prompted to make some input which represents an action required in one or both of bingo games 1 and 2. The EPSs may also display entertaining graphics during this time period, or at least between the time that the player completes their input to initiate the game play requests and the time the Daub Now display appears. The entertaining graphics may include spinning reels to imitate the spinning reels of a slot machine, graphics with some other casino game theme, or any other manner of graphics. Such entertaining graphics may also continue for some portion of time period T3 after the player makes the required input. Regardless of the graphics displayed to prompt the player, the “Daub Now” display or some portion of the display at time period T3 prompts the player at the respective EPS to take the required action and potentially claim a prize. In some preferred forms of the invention, a separate input is required for each separate game in which the player is participating, that is, for each separate game play request initiated by a player. In other forms of the invention, an input may be required only to claim a winning prize or a game ending winning prize. However, in preferred forms of the present invention, a single input at an EPS when the EPS is in the Daub Now display state represents an input in each of the concurrent bingo games 1 and 2.

In the example illustrated in FIG. 4, it is assumed that by time period T4 player 3 has failed to make the required input at their EPS 103 to claim their game ending win for game 2 and that players 1 and 2 have made the required input at their respective EPS. Thus, at time period T4, player 3's EPS remains at the “Daub Now” display state due to player 3's failure to make the required input at the respective EPS. However, since player 2 has taken the required action, that is, made the required input to claim their game ending prize for game 1, the game 1 results are available to be displayed or presented to the respective players at time period T4. Thus, player 2's EPS displays player 2's result, “W end” for game 1, and player 1's EPS displays player 1's result for game 1, a result represented by “Win” in FIG. 4.

At time period T5, it is assumed for the purposes of the example shown in FIG. 4 that player 3 has taken the required action, that is, made the required input at their EPS, to claim their game ending win for game 2. Thus, the results for game 2 are available to be displayed or presented at each player's EPS during time period T5. Player 1's EPS presents the losing result for game 2 as indicated by the “L” for the player 1 EPS in FIG. 4 at time period T5. Similarly, player 2's EPS presents the losing result for game 2 as indicated by the “L” for player 2. Also, player 3's EPS presents player 3's game ending win for game 2 during time period T5. It will be noted that even though game 2 is relatively slow to end in this example, that delay does not result in any delay to players 1 and 2. Rather, a portion of the time required to make game 2 results available at time T5 is taken up at player 1's EPS and player2's EPS by the time required to make the game result presentations or displays at time T4. That is, rather than having to wait for all game play results to become available, the present system uses the time required to present already available results to occupy a player at their EPS while the remaining game play results remain in the process of being made available.

At time period T6 players 1 and 2 have been shown their results for both games 1 and 2 and thus are able to begin a new game sequence. The player 1 EPS shows a “Request Play” display state at T6 and player 2's EPS shows a “Preliminary Display” state at this time period. The difference between the display states at time period T6 for the player 1 EPS and player 2 EPS may be set by player preference or in any other fashion. That is, player 1 may have selected an option at time period T1 to go directly to a “Request Play” display state after all results for a set of game play requests have been presented. Alternatively, the player 1 EPS may be set in some other fashion to proceed immediately to the “Request Play” state. Player 2 may have selected an option earlier to return the EPS to the “Preliminary Display” state when all results in previous bingo games have been presented or may have selected an EPS that behaves in that fashion.

In the example shown in FIG. 4, the player 3 EPS presents player 3's losing result for game 1 at time period T6. It should be noted that although player 3's EPS is shown to display player 3's game 2 result at T5 in FIG. 4, and then player 3's game 1 result at time T6, the result order could have been switched. That is, the player 3 EPS could have displayed results from game 1 at T5 because the results of game 1 had been available since T4, and then could have gone on to present the game 2 result at time period T6. Gaming system 100 may be configured to show available results in some order to achieve a desired goal. For example, it may be desirable for the player to see winning results first, in which case winning results would be selected to be presented first. Alternatively, it may be deemed more desirable to evenly distribute winning results over time. The invention encompasses any result presentation order such as these which are at least partially based upon the availability of results for the various simultaneous or concurrent game play requests.

It will be noted that since player 3's results for both games 1 and 2 are available at time period T5, it may be possible to combine the results of the two game play requests for games 1 and 2 into a single combined or composite result at time T5. Since one of the two game results is a losing or no payout result in this particular case, the result presentation for the combined result could be the same as if the winning result was presented by itself. In other cases, the combined results could both be winning results associated with some payout. In these cases, the combined result would be presented in some fashion to represent the cumulative winnings, that is, the value of the first winning result plus the value of the second winning result. In any case, combining the results into a combined result presented in one time period, allows the player 3 EPS to return more quickly to a state in which they may enter further game play requests. That is, if combined results are shown for player 3's game 1 and game 2 results, the combined result may be presented at time T6 and then the player 3 EPS could return to the Request Play state at time T7.

In the illustrated scenario of FIG. 4, the player 2 EPS does not return to the Request Play state until time period T7, and the player 3 EPS does not return to the Request Play state until time period T8. In the mean time, player 1 has already made the input or inputs necessary to initiate another group of game play requests and the player 1 EPS is in the Daub Now display state at time T7. The player 2 EPS does not reach this display state until time T8 and the player 3 EPS does not reach the Daub Now display state until after time T8. Again, since they initiated play earlier, player 1 is already receiving results for their next bingo games at time T8. It will be noted that a player's respective game play requests initiated after the respective player receives their results from the previous set of game play requests are very likely grouped together with game play requests from entirely different players. This is particularly true where the gaming system 100 includes many EPSs 103 all networked together to a common bingo game result module element such as CGS 101 in FIG. 1 to group game play requests. Even where players enter game play requests at near the same time, the game play requests may not be grouped together for the next game if the new game groups are formed from requests across a large network and the game groups are limited to only a few game play requests to make a quorum to start a bingo game.

FIG. 5 shows the results that may be generated when five players participate in the same five bingo games according to the present invention. That is, FIG. 5 is a table illustrating game results representing a state of the bingo gaming system of FIG. 1 when five players each make five game play requests where the five games are carried out simultaneously or concurrently with the same five players.

The time line table of FIG. 6 illustrates a potential order for the display of the game results from the table of FIG. 5. It will be assumed that players 1, 4, and 5 take the required action (for example enter a daub input and/or prize claiming input) more quickly than players 2 and 3 with player 3 taking the longest time to take the required action. Game results may not be displayed until the respective game is completed, that is, when the game ending winner takes the required action to claim the game ending win. In other words, any game where player 3 has a game ending win is delayed until player 3 takes the required action at their EPS, whatever that action or set of actions might be. Prior to time period T1 in FIG. 6, it may be assumed that players 1-5 each made five game play requests and these five game play requests from each player were all grouped together in the same five bingo game groups. It will also be assumed in the example of FIG. 6 that results are ordered for display for each player in the order the results became available. This may be accomplished using result ordering module comprising a first-in-first-out (FIFO) queue for each player or EPS to receive bingo game results as they become available and then release the respective results as the player's display becomes available to display further results. It will also be assumed for purposes of this example that the results for the five games become available in the following order, game 1, game 3, game 5, game 2, and finally game 4.

Column T1 of FIG. 6 shows that players 1, 4, and 5 have taken the required action indicated by the designation “Daub” for purposes of this example and that players 2 and 3 have not yet taken the required action at their respective EPS but still have displays prompting the action as indicated by “Daub Now” in the figure. Thus, the results which have been identified by the bingo game result module (CGS 101 in FIG. 1 for example) for games 1, 3, and 5, the games in which players 1, 4, and 5 achieved game ending wins, become available some time during time T1.

At time period T2, since players 1, 4, and 5 have taken the required actions for all of the games 1-5, results from one of the completed games, in this example the game 1 results, are presented or displayed to players 1, 4, and 5 for their respective game play requests that were grouped in game 1. However, since player 2 is just taking the required action in time T2 and since player 3 has not yet taken the required action, the EPS for these players do not present any results in these time periods. Also, although player 2 takes the required action in time T2, their action does not make any further results available because they achieved no game ending pattern in any of the five games.

During time T3, player 3 finally takes the required action to claim the game ending wins for games 2 and 4 and thus the results for games 2 and 4 become available in time period T3. For all of the players other than player 3, the respective EPS presents the results for another one of the games for which results are available. In this particular example, time period T3 is used to show players 1, 4, and 5 their respective result for game 3, and to show player 2 their respective result for game 1.

As all of the game results are available at this point, and no player is occupied waiting to take an action or actually taking a required action, each player's EPS presents a result to the respective player in time period T4. In this example, players 1, 4, and 5 receive displays showing game results for game 5. Player 2 receives a display of their result for game 3, and player 3 receives a display of their result for game 1. Again, these displays correspond to the order of displays from the FIFO result queue associated with each player or EPS.

Because game 2 results are available and next in the queue for players 1, 4, and 5, those players receive displays for game 2 results during time period T5, while player 2 receives a display for results from game 5 and player 3 receives a display for results from game 3. At T6, players 1, 4, and 5 receive displays for their respective game 4 results while player 2 receives a display for results from game 2, and player 3 receives a display for results from game 5.

By time period T7 players 1, 4, and 5, the players who took the required action in the five games initiated at T0 in FIG. 6, have already been shown all of the results for games 1 through 5. Thus, the respective EPS for each of these players may present a “Request Play” display to the respective player which allows the respective player to make an input to enter one or more game play requests to be grouped for further bingo games conducted by the system. However, since results for games are yet to be displayed to player 2 and player 3, the transition into new games does not begin until time T8 for player 2 and does not begin until time T9 for player 3. At T7, player 2 receives a display for results from game 4 and player 3 receives a display for results from game 2. At T8, player 3 receives a display for results from game 4 which completes the result displays for all the players that participated in games 1 through 5.

At T7, it is assumed that players 1, 4, and 5 each make the input or inputs required to make additional game play requests for additional bingo games. Each of these players enters the required actions to claim any prizes at time period T8 and are then displayed results at time T9.

The invention encompasses numerous variations on the basic result presentation process illustrated in the example of FIG. 6. In each case, each player initiates a number of different game play requests and each request for a respective player is grouped together with game play requests from other players into different bingo games. Some of the results from the bingo games may be available sooner than other of the bingo games due to slow action by some players to claim their prizes or for other reasons. The present invention utilizes the presentations of the earlier available results to occupy the players who have acted quickly to take the required actions while the results from other games become available. Thus, the present invention helps prevent the situation in which a player is idle at an EPS while waiting for bingo game results or result presentations. The quicker players remain occupied with entertaining result presentations while the other players are taking their time to play the games and make the required inputs.

Among the many variations within the scope of the present invention it will be noted that the result queue or other result storage arrangement for each player or EPS need not comprise a FIFO queue. Rather, results may be selected from the queue or other storage arrangement in any order to suit any purposes. For example, it may be desirable for the first result presentation that each player sees be a winning result. Thus, winning results may be selected from the queue first. Alternatively, it may be desirable to distribute the winning result presentations. Thus, logic may be included with the result ordering module or modules in the system to ensure that winning results are taken from the player's result queue in an order to ensure such an even distribution of winning results over the various result presentations to be made.

It will also be apparent that each player need not participate in the same bingo games with the same players to effect the desired dynamic ordering of bingo game results and result presentations. The example shown in FIGS. 4 and 5, in which all five players participate in the same bingo games, is shown only for ease of description. In other situations and forms of the invention, each of the five players may be playing bingo games with different players. The results from the bingo games with those different players may become available in the same order as shown in FIG. 6 or in a different order. In each case, however, the result presentations are dynamically ordered based at least in part on the availability of the results so that players may be occupied with result presentations for the completed games while other game results become available.

The variation in the present invention discussed above with reference to FIGS. 3 and 4 with regard to combining certain bingo game results may also be illustrated with reference to FIG. 6. As shown in FIG. 6, it will be noted that all results for the five different bingo games are available after time period T3. Since all results are available at this point, there is no reason to occupy players with result presentations while other results become available. In this case, the present invention may combine the results that have not previously been displayed individually into a combined or composite result for each respective player and present that combined result at time period T4. For example, player 1 would see the single winning result at time T4 for game 4 and player 5 would see a result at time T4 representing the sum of the results for games 5 and 2 (assuming the FIFO result queue arrangement described with reference to FIG. 6). Combining results into a single presentation at time T4 would allow players to receive all of the results for the first 5 games by that time and be in position to initiate additional game play requests at time period T5 in FIG. 6, further accelerating play in the bingo games. A similar effect may be produced by accelerating the result displays rather than combining them. For example, once the results are all available at time T4, each player's EPS may go into a “rapid presentation” mode in which result presentations remaining to be displayed to the players are displayed rapidly in the single time period T4 or at least over fewer time periods than would otherwise be required at a normal result presentation speed. Other displays at an EPS 103 in system 100 may be accelerated within the scope of the invention to speed game play.

As will become apparent to one of ordinary skill in the art and viewing the disclosed embodiments, further variations for reordering the display of game results in simultaneously or concurrently played games in the disclosed bingo system are possible and are within the scope of the appended claims. The above described preferred embodiments are intended to illustrate the principles of the invention, but not to limit the scope of the invention. Various other embodiments and modifications to these preferred embodiments may be made by those skilled in the art without departing from the scope of the invention.

1. A method including:
(a) receiving at least two bingo game play requests from a first player and at least one additional player;
(b) grouping the bingo game play requests such that the at least two respective bingo game play requests for the first player are included in different bingo games;
(c) conducting each respective bingo game to identify a result for each bingo game play request included in the respective bingo games; and
(d) presenting the result for each of the at least two bingo game play requests received from the first player, the results for the at least two bingo game play requests received from the first player being presented to the first player in an order based at least partially on game result availability for the respective bingo games.

2. The method of claim 1 wherein the results for the at least two bingo game play requests received from the first player are presented sequentially to the first player.

3. The method of claim 1 wherein the results for the at least two bingo game play requests received from the first player are presented to the first player simultaneously in a combined result presentation.

4. The method of claim 1 wherein the results for the at least two bingo game play requests received from the first player are presented to the first player in an order to avoid delays in presenting the results for at least one of the two bingo games to the first player where such delays are introduced by the at least one additional player.

5. The method of claim 1 further including the step of storing the result for at least one of the at least two bingo game play requests in a result ordering queue.

6. An apparatus including:
(a) two or more player stations, each respective player station including a display;
(b) a bingo game result module for receiving two or more respective game play requests initiated through each of two or more respective player stations and for identifying a bingo game result for each respective game play request; and
(c) a result ordering module for receiving the respective bingo game result for each respective game play request initiated through at least one player station and for determining a result presentation order for the received bingo game results from among a number of possible result presentation orders, and
(d) wherein the at least one player station produces a graphic result presentation for each respective game play result for each respective game play request initiated through the at least one player station in the result presentation order determined by the result ordering module.

7. The apparatus of claim 6 wherein the result ordering module determines the result presentation order by an order in which the received bingo game results are received by the ordering module.

8. The apparatus of claim 6 wherein the bingo game result module identifies the respective result for each game play request after a required player action taken through one of the at least two player stations.

9. The apparatus of claim 6 wherein the result ordering module combines at least two of the received bingo game results to provide a composite result and wherein the at least one player station produces a graphic result presentation for the composite result.

10. A program product stored on at least one storage medium, the program product including a set of machine-readable instructions that when executed are configured to:
(a) receive at least two bingo game play requests from a first player and at least one additional player;
(b) group the received bingo game play requests such that the at least two respective bingo game play requests for the first player are included in different bingo games;
(c) conduct each respective bingo game to identify a result for each of the at least two respective bingo game play requests for the first player; and
(d) present the result for each of the at least two bingo game play requests to the first player in an order at least partially based on result availability for the respective bingo games.

11. The program product of claim 10 wherein the set of machine readable instructions further includes instructions executable to sequentially present to the first player the results for the at least two bingo game play requests received from the first player.

12. The program product of claim 10 wherein the set of machine readable instructions further includes instructions executable to present to the first player a composite result representing a combination of the results for the at least two bingo game play requests received from the first player.

13. The program product of claim 10 wherein the set of machine readable instructions further includes instructions executable to present to the first player the results for the at least two bingo game play requests received from the first player in an order to avoid delays in presenting the results for at least one of the two bingo games to the first player where such delays are introduced by the at least one additional player.

14. The program product of claim 10 wherein the set of machine readable instructions further includes instructions executable to store in a result ordering queue the result for at least one of the at least two bingo game play requests received from the first player.

15. A method including:
(a) collecting bingo game play requests from a number of player stations into at least two groups of bingo game play requests for different bingo games;
(b) conducting each respective bingo game to identify a respective result for each respective bingo game play request included in the respective bingo game; and
(c) receiving a player action in the course of conducting at least one of the bingo games and applying the player action in each of the different bingo games.

16. The method of claim 15 wherein collecting bingo game play requests from the number of player stations into at least two groups of bingo game play requests for different bingo games includes collecting multiple bingo game play requests from at least one player station in response to a single player input.

17. The method of claim 16 further including the step of receiving from the at least one player station an input identifying a number of bingo game play requests to include in the single player input.

18. The method of claim 15 wherein the player action includes a bingo card daub input.

19. The method of claim 18 wherein the player action includes a bingo prize claiming input.

20. The method of claim 15 wherein the bingo game results for the bingo game play requests collected from at least one player station are presented at the at least one player station in an order at least partially based upon availability of the bingo game results for the game play requests collected from the at least one player station.
